(19) United States
(12) Patent Application Publication
(10) Pub. No.: US 2012/0135692 A1
(43) Pub. Date: May 31, 2012

(54) WIRELESS REMOTE CONTROLLED DEVICE SELECTION SYSTEM AND METHOD

(75) Inventors: Lorenzo Feri, Eindhoven (NL); Johan Cornelis Talstra, Eindhoven (NL); Hendricus Theodorus Gerardus Maria Penning De Vries, Eindhoven (NL); Ronald Rietman, Eindhoven (NL)

(73) Assignee: KONINKLIJKE PHILIPS ELECTRONICS N.V., EINDHOVEN (NL)

(21) Appl. No.: 13/263,106

(22) PCT Filed: Apr. 1, 2010
(86) PCT No.: PCT/IB10/51419

§ 371 Date: Feb. 20, 2012

(30) Foreign Application Priority Data
Apr. 8, 2009 (EP) 09157582.9

(51) Int. Cl. H04B 17/00

(52) U.S. Cl. 455/67.14

(57) ABSTRACT

The invention relates to a wireless remote controlled device selection system for selecting devices. Signal processing provides information for a remote control device. This information is indicative of the angle between the remote control device and the various devices from which a device should be selected. By analyzing the angular deviations, the desired device can be selected.

### FIELD OF THE INVENTION

The invention relates to the field of selecting one or more devices out of a plurality of devices, such as lamps, by means of a wireless remote control device.

### BACKGROUND OF THE INVENTION

In current lighting systems, including multiple lamps, selection and control of the lamps usually occurs by fixed devices, such as wall panels having switches. The switches are used to control the lamps, such as to turn lights on or off, or dim the lights. In the event a user desires to change any of the lights, the user must return to the wall panel. Of course, the user needs to know which switch controls which lamp. Often, however, the user does not have such information as switches and lamps are not marked. Such a situation is particularly problematic in the case of multiple lamps and multiple switches. The switch that controls the desired lamp then has to be found by trial and error.

Recent developments have created remote control devices useful for selecting lamps by pointing at them and subsequently adjusting the lamps. The use of remote control devices, however, provides the risk of accidentally selecting a device (e.g. a lamp) other than the desired device. This situation is particularly encountered where multiple devices are positioned closely together in relation to the distance between these devices and the remote control. Therefore, a trade-off must be made between ease of selecting a device (favoring a wide selection field of view from the remote control) and avoiding the risk of selecting multiple devices (favoring a small selection field of view from the remote control).

US2003/0107888 discloses a remote-control modular lighting system utilizing a directional wireless remote control for the selective adjustment and programming of individual lighting modules. Individual lighting modules may be selected for adjustment by momentarily pointing the remote control at the lighting module to be adjusted. Subsequent adjustments may be done without aiming at the lamp, allowing the operators attention to be focussedon the subject being lit. The adjustments may include switching on/off, dimming and aiming the light of the lamp. If lighting modules are spaced tightly such that multiple modules are selected, the remote control comprises an added feature enabling a user to cycle through the selected lamps by pressing a select button repeatedly, until an indicator on the desired lamp module lights.

There exists a need in the art for providing an improved system and method for selecting at least one device, such as a lamp, out of a plurality of devices.

### SUMMARY OF THE INVENTION

A wireless remote controlled device selection system is proposed. The system includes a first target device comprising a first signal transmitter configured for transmitting a first signal and a second target device comprising a second signal transmitter configured for transmitting a second signal. The system also includes a remote control device configured for selecting at least one of the first target device and the second target device. The remote control device includes a directional signal receiver, an omni-directional signal receiver, a processor, and a selector. The directional signal receiver is configured for determining a first test power of the first signal transmitted from the first signal transmitter to the directional signal receiver and a second test power of the second signal transmitted from the second signal transmitter to the directional signal receiver. The omni-directional signal receiver is configured for determining a first reference power of the first signal transmitted from the first signal transmitter to the omni-directional signal receiver and a second reference power of the second signal transmitted from the second signal transmitter to the omni-directional signal receiver. The processor is configured for determining a first intention factor based on a first instantaneous ratio between the first test power and the first reference power, or function/derivation of that ratio (e.g., signal strength) and determining a second intention factor based on a second instantaneous ratio between the second test power and the second reference power, or a function/derivation of that ratio (e.g., signal strength). The selector is configured for selecting the first target device when the first intention factor satisfies a first selection condition and selecting the second target device when the second intention factor satisfies a second selection condition.

In various embodiments, each of the directional and the omni-directional signal receivers may comprise an arrangement of a plurality of receiver modules, such as photo detectors, each of the receiver modules being connected to a signal strength processing module for processing the signal strength of the signals from the various target devices. The remote control device may comprise a motion sensor and a start module to trigger transmission of the first signal and the second signal in response to detecting movement of the remote control device by the motion sensor. Thus, energy may be saved by triggering transmission of the first and second signals only upon handling the remote control device.

Moreover, an alternative wireless remote controlled device selection system is proposed that includes a first target device comprising a first signal receiver and a second target device comprising a second signal receiver. The system also includes a remote control device comprising a directional signal transmitter, and an omni-directional signal transmitter. The directional signal transmitter is configured for transmitting a directional signal to the first and second signal receivers. The omni-directional signal transmitter is configured for transmitting an omni-directional signal to the first and second signal receivers. In operation, the first signal receiver is configured for determining a first test power of the directional signal transmitted from the directional signal transmitter to the first signal receiver, and a first reference power of the omni-directional signal transmitted from the omni-directional signal transmitter to the first signal receiver. The second signal receiver is configured for determining a second test power of the directional signal transmitted from the directional signal transmitter to the second signal receiver, and a second reference power of the omni-directional signal transmitted from the omni-directional signal transmitter to the second signal receiver. The system further includes processing means for determining a first intention factor as a first instantaneous ratio between the first test power and the first reference power, or derivation thereof (e.g., signal strength) and determining a second intention factor as a second instantaneous ratio between the second test power and the second reference power, or derivation thereof (e.g., signal strength). The system also includes selecting means for selecting the first target device when the first intention factor satisfies a first selection condition and selecting the second target device when the second intention factor satisfies a second selection condition.

In various embodiments, each of the directional and the omni-directional signal transmitters may comprise an arrangement of a plurality of transmitter modules, such as photo transmitters. The transmitter modules being configured to transmit coded directional signals and coded omni-directional signals. The signal receivers of each target device are connected to signal strength processing modules for processing the signal strength of the directional and the omni-directional signals.

The gist of the invention resides in the observation that by calculating the instantaneous ratio between the power of test radiation (characterized by a directional signal pattern) and the power of the reference radiation (characterized by an omni-directional signal pattern), a value may be derived that is indicative of the angle between the pointing direction of the remote control device and an imaginary line connecting the remote control device and the target device. That value is referred to herein as an “intention factor”. The intention factor is larger for smaller angles. By testing whether the intention factor satisfies a selection condition, a decision can be taken for the selection of a given target device.

As used herein, the term “test radiation” refers to signals communicated between the remote control device and the target devices over a directional channel, while the term “reference radiation” refers to signals communicated between the remote control device and the target devices over an omni-directional channel.

The selection based on the instantaneous ratios of test power and reference power may involve a corresponding selection based on a function of these ratios.

The system wherein the first and second signals are emitted from the target devices towards the remote control device as defined in claim 1, also referred to as a directed receiver system, is advantageous in that the information indicative of the first and second angles is readily available at the remote control device in order to select the appropriate device. Moreover, a first or second target device using one or more optical receivers, such as photo detectors, is generally more expensive than a first or second target device requiring optical transmitters.

The system wherein the first and second signals are emitted from the remote control device towards the target devices to be selected as defined in claim 6, also referred to as a directed transmitter system, is advantageous in that such a system provides a good signal-to-noise ratio as a result of the fact that the directional signal is already predominantly aimed at the target device that the user desires to select. Moreover, such a system does not require synchronization between the first and second target devices.

It should be noted that in the directed transmitter system, either the remote control device or the target device may determine the selection. For example, according to claim 8, processing and selecting may be performed at the target device and the target device may select itself when the intention factor for this device satisfies a selection condition. Thus, every target device may be allowed to take an independent selection decision. Alternatively, also other devices (such as another lamp) containing a data receiver for receiving information relating to the intention factors may determine the selected target device. In other words, the selection decision may be made externally of the remote control device and only the result may be reported to the remote control device. According to claim 11, processing and selection may also be performed at the remote control device.

It should further be appreciated that the selection systems may also be used for selecting a group of at least two target devices. These target devices may e.g. be selected on the basis of determining two largest intention factors.

The embodiments defined in claims 2, 9, and 15 allow determining an increasingly larger intention factor as an integral of the instantaneous ratio over a time period.

The embodiments defined in claims 3 and 10 allow selecting a target device by comparing the intention factors of the different target devices and selecting the device corresponding to the lowest angle between the target device and the remote control device—i.e. between the direction in which the remote control device is pointing and the imaginary line connecting the remote control device and the target device.

The embodiments defined in claims 4 and 7 allow selecting some target devices independently of the other target devices by comparing the intention factors with threshold values.

The embodiments of claims 5 and 12 allow disabling the selection of further target devices once one of the target devices has been selected. Claims 13 and 14 define methods for operating the directed receiver and directed transmitter systems, respectively.

In one embodiment, the first signal, second signal, directional signal, and the omni-directional signal may comprise optical signals (such as visible or infrared). However, in other embodiments, radio frequency signals (e.g. 60 GHz) or ultrasound signals (>20 kHz) may also be used. Radio frequency signals have the advantage of penetrating certain materials thereby possibly improving the detection of the first and second signals. Ultrasound may enable the use of measures other than signal strength (such as phase) as an indication of the angle between the remote control device and the target device.

In various embodiments, the target devices may comprise lamp devices containing one or more light emitting elements. The light emitting elements themselves may be used as transmitters of the first and second signals, thereby eliminating the need for separate transmitters. The first and second signals from the target devices may comprise unique codes in a manner described in WO2006/111930 and WO2009/010909.

The selection of the target devices may be performed after a predetermined delay time, thus preventing a spurious selection when a user sweeps the remote control device across the first and second target devices without the intention of selecting them.

The remote control device may comprise a relatively simple handheld device and a sophisticated central controller for processing, where the central controller would function as an intermediary device between the handheld device and the first and second target devices.

Hereinafter, embodiments of the invention will be described in further detail. It should be appreciated, however, that these embodiments may not be construed as limiting the scope of protection for the present invention.

### BRIEF DESCRIPTION OF THE DRAWINGS

In the drawings:

FIG. 1 shows a schematic illustration of a wireless remote controlled device selection system installed in a structure according to an embodiment of the invention;

FIG. 2 shows a schematic illustration of a directed receiver wireless remote controlled device selection system according to an embodiment of the invention;

FIG. 3 shows a schematic illustration of a directed transmitter wireless remote controlled device selection system according to an embodiment of the invention

FIGS. 4A and 4B show diagrammatic illustrations of the operation of the device selection system of FIGS. 2 and 3, respectively according to an embodiment of the invention;

FIG. 5 shows a function that describes an intention factor Q for various angular distances u;

FIG. 6 shows the use of intention factors in combination with threshold values in selecting target devices according to an embodiment of the invention;

FIG. 7 is a schematic illustration of further components of a remote control device that may advantageously be used for a remote control device in the wireless remote controlled device system according to an embodiment of the invention;

FIGS. 8A and 8B are schematic illustrations of a first target device according to an embodiment of the invention; and

FIG. 9 shows an alternative application of the wireless remote controlled device selection system.

### DETAILED DESCRIPTION OF THE DRAWINGS

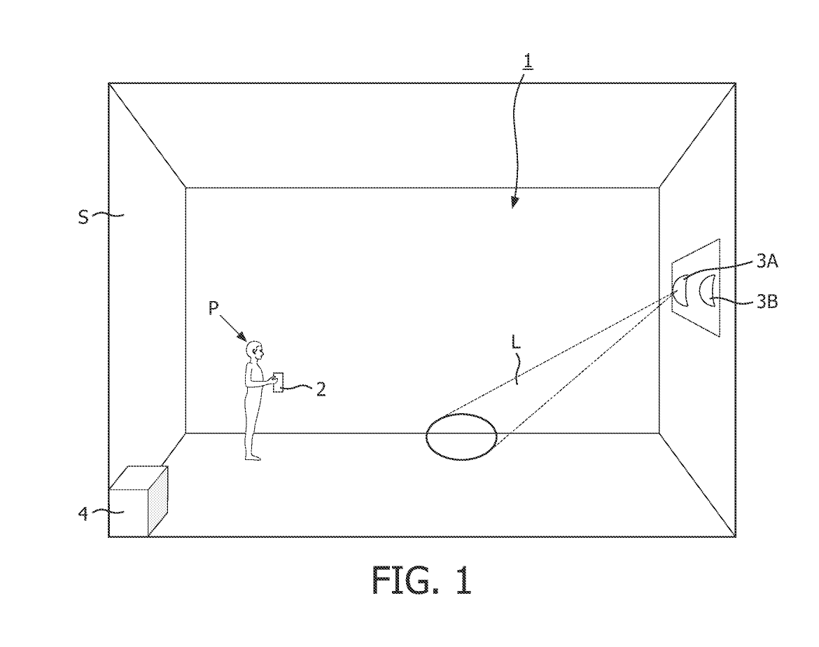

FIG. 1 is a schematic illustration of a wireless remote controlled device selection system 1, i.e. a system wherein target devices 3A, 3B in a construction S are wirelessly selected by means of a remote control device 2. In the following, the two target devices 3A, 3B are assumed to be lamps, but may represent alternative devices, such as e.g. electronic appliances, awnings, switches or doors. Of course, in other embodiments, the system 1 may include more than two target devices.

The remote control device 2 may be a single handheld device or a combination of a handheld device and a central controller 4.

Person P may, through the use of the remote control device 2, control the operation of the lamps 3A, 3B. The control relates e.g. to switching the lamps 3A, 3B on/off, controlling the light intensity or the color of the light L emitted by the lamps 3A, 3B and/or controlling the direction in which the light L is emitted from the lamps 3A, 3B.

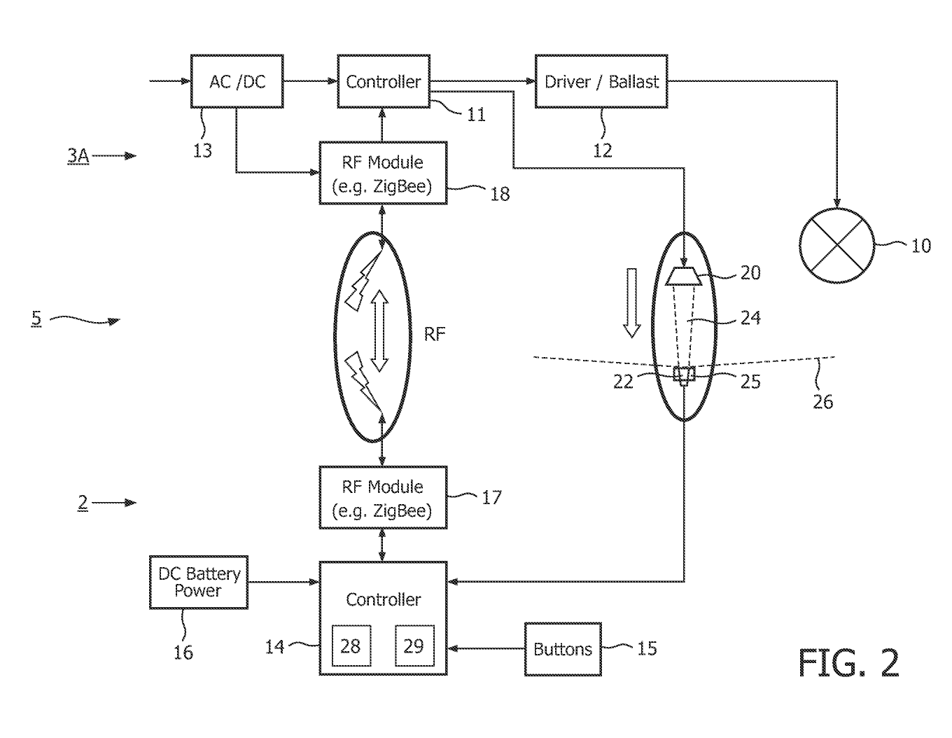

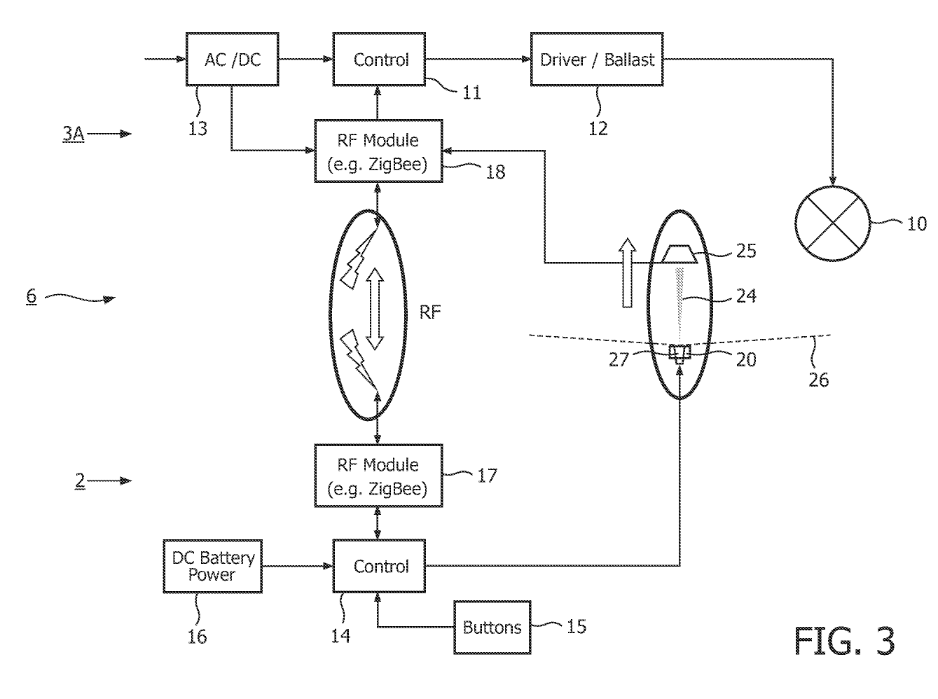

FIGS. 2 and 3 provide schematic illustrations of a directed receiver system 5 and a directed transmitter system 6, respectively, for selecting and controlling a lamp 3A (or 3B) using a remote control device 2. Either one of the systems 5 and 6 may be implemented as the system 1 illustrated in FIG. 1.

In both systems, the lamp 3A comprises a light emitting element 10 controlled from a controller 11 via a driver 12 in response to a signal received from an AC/DC converter 13. While such an arrangement is typical, persons skilled in the art will recognize that this arrangement is not always necessary. In other embodiments, there may not always be a driver 12 but just a simple switch (e.g. for incandescent lamps).

In both systems, the remote control device 2 comprises a controller 14 configured for receiving commands from the person P operating buttons 15. The remote control device 2 also contains a battery 16.

In both systems, both the remote control device 2 and the lamp 3A may further comprise a communication module 17, 18 enabling communication between the remote control device 2 and the lamp 3A via an omni-directional radio frequency link RF. The RF link may use a predefined protocol, such as ZigBee, for transmitting information between the remote control device 2 and the lamp 3A, such as control commands input by the person P using the buttons 15.

Providing control signals to the lamps 3A, 3B, either directly or via the central controller 4, presupposes that the lamp 3A, 3B that should be controlled has been selected.

To that end, in one embodiment of the directed receiver system 5 of FIG. 2, lamp 3A may comprise a signal transmitter 20 controlled from the controller 11. The signal transmitter 20 may e.g. be driven by a light emitting diode (LED) driver not shown in FIG. 2. The signal transmitter 20 has a substantially omni-directional radiation pattern, at least within (a fraction of) an opening angle of the lamp 3A. The remote control device 2 comprises a directional signal receiver 22 that includes a detector (not shown in FIG. 2) for detecting signals communicated over a directional channel 24 from the signal transmitter 20. Remote control device 2 also includes an omni-directional signal receiver 25 that includes a detector (not shown in FIG. 2) for detecting signals communicated over an omni-directional channel 26. The signals communicated over the channels 24 and 26 are e.g. infrared signals and are intended for selecting the lamp 3A.

By contrast, in the directed transmitter system 6 of FIG. 3, the remote control device 2 contains the omni-directional signal transmitter 20, and the lamp 3A contains the omni-directional signal receiver 25 that includes a detector (not shown in FIG. 3) for detecting signals communicated over the omni-directional channel 26 from the signal transmitter 20. The remote control device 2 in the directed transmitter system 6 further includes a directional signal transmitter 27. The radiation pattern of the directional signal transmitter 27 is Lambertian with order n sufficiently high to make the signal transmitted by the directional signal transmitter 27 a focused beam. The detector within the signal receiver 25 is further configured for detecting signals communicated over the directional channel 24 from the directional signal transmitter 27. Again, the signals communicated over the channels 24 and 26 are e.g. infrared signals and are intended for selecting the lamp 3A. In the directed transmitter system 6, once a lamp 3A detects that it has been selected, this is communicated over the radio link RF to the remote control device 2.

In both systems, selection of the lamp 3A is typically performed by aiming the remote control device 2 at the lamp, such that, in the directed receiver system 5, the directional signal receiver 22 determines the power of a signal received from the lamp 3A over the directional channel 24 and the omni-directional signal receiver 25 determines the power of the signal received from the lamp 3A over the omni-directional channel 26. In the directed transmitter system 6, the signal receiver 25 determines the power of a directional signal received from the directional signal transmitter 27 over the directional channel 24 and the power of an omni-directional signal transmitted by the omni-directional signal transmitter 20 over the omni-directional channel 26.

Once the lamp 3A is selected, a network address of lamp 3A is transmitted to the remote control device 2 over radio link RF. In this manner, after the selection of the lamp 3A, the control signals include the network address, alleviating the need to aim the remote control device 2 in the direction of the lamp 3A for transmitting control signals to the lamp 3A over the radio link RF.

The present disclosure relates to a method for improving the accuracy of selecting the lamp 3A and/or 3B using the remote control device 2. This aspect is especially important in a situation wherein the lamps 3A and 3B are at a close distance as compared to the distance between the remote control device 2 and the lamps 3A, 3B.

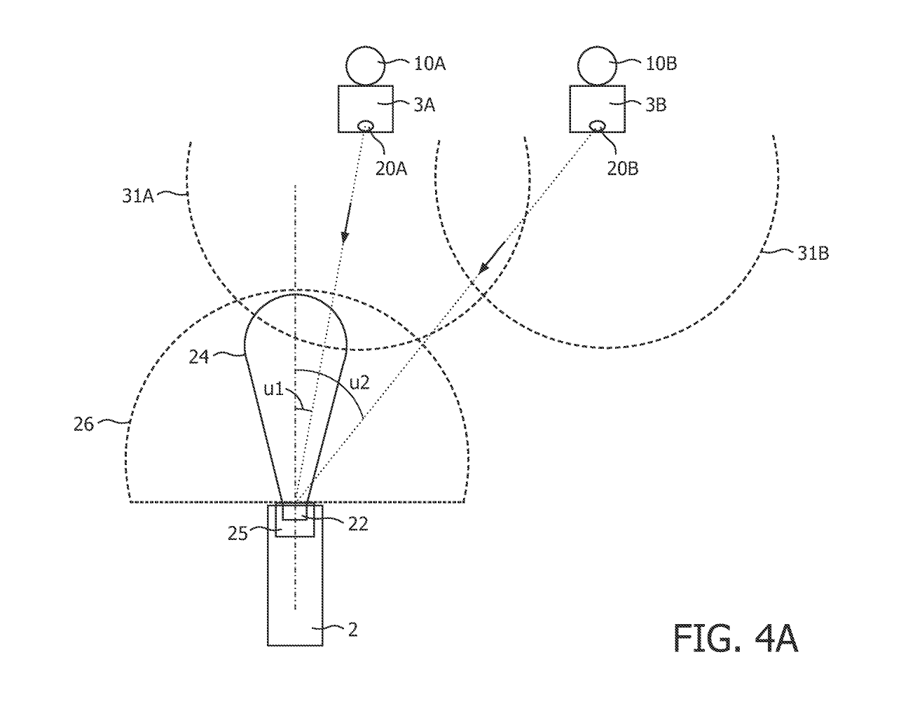

FIGS. 4A and 4B depict diagrams for the directed receiver system and directed transmitter system, respectively, illustrating the improved system and method. FIG. 4A is a schematic diagram of the directed receiver system 5. As shown, a directed receiver system includes a first lamp 3A comprising a first signal transmitter 20A, and a second lamp 3B comprising a second signal transmitter 20B. In operation, the first signal transmitter 20A transmits a first signal and the second signal transmitter 20B transmits a second signal. The signal transmitter 20 has a substantially omni-directional radiation pattern, at least within (a fraction of) an opening angle of the lamp 3, shown as patterns 31A and 31B for the lamps 3A and 3B, respectively.

Any technique that allows reliable detection and avoids interference between the signals transmitted by different lamps may be used. For example, frequency division multiple access (FDMA) technique may be used where the signal transmitters 20A and 20B use two different modulation frequencies. Any other technique for multiple access would function as well, such as time division multiple access or code division multiple access techniques. The first signal may contain an identification code of the first lamp 3A and the second signal may contain an identification code of the second lamp 3B. The identification codes may be preferably chosen such that they are (quasi-) orthogonal with respect to each other in order to minimize interference between the first and second signals.

In some cases, it may be impractical to provide the lamps 3A, 3B with signal transmitters 20A, 20B. Instead of using separate signal transmitters, in such cases, the light emitting elements 10A, 10B may be used for transmitting the first and second signals.

The system of FIG. 4A also includes the remote control device 2 comprising the directional signal receiver 22 and the omni-directional signal receiver 25. The directional signal receiver 22 determines the power of the first signal as received from the lamp 3A over the directional channel 24 (Ptest1) and the power of a second signal as received from the lamp 3B over the directional channel 24 (Ptest2). The omni-directional signal receiver 25 determines the power of the first signal as received from the lamp 3A over the omni-directional channel 26 (Pref1) and the power of the second signal as received from the lamp 3B over the omni-directional channel 26 (Pref2).

While the signal receivers 22 and 25 are shown in FIGS. 2 and 4A to be overlapping, in practical situations, the signal receivers 22 and 25 may be mounted in adjacent positions. This would lead to an approximation that is adequate when the distance between the remote control device 2 and the lamps 3A, 3B is significantly larger than the distance between the signal receivers 22 and 25.

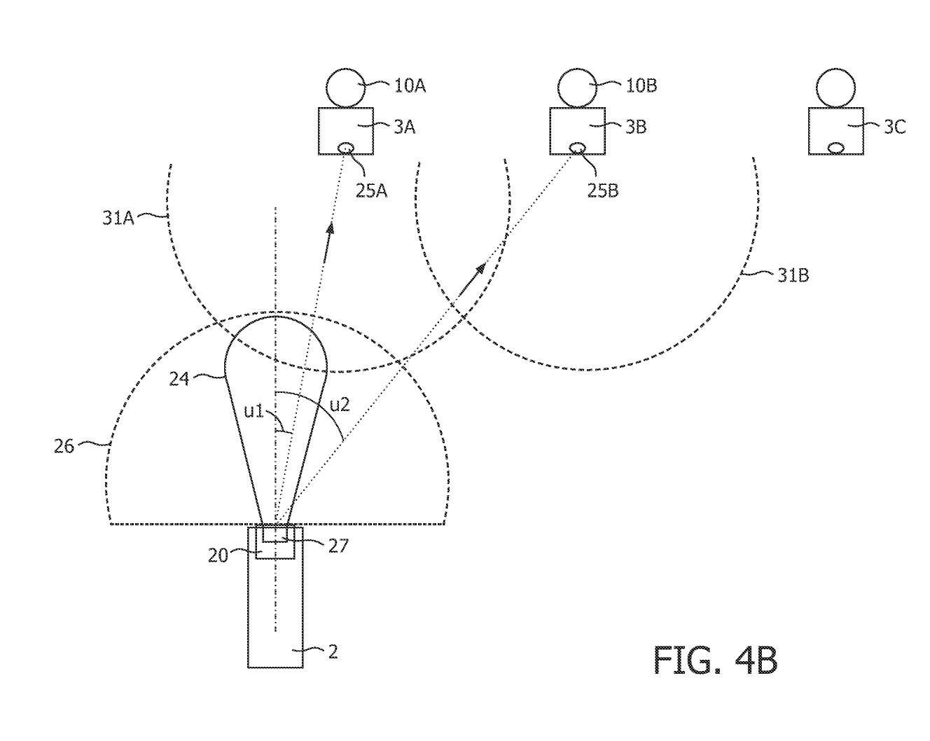

The remote control device 2 comprises the controller 14 (see FIG. 2) having processing functionality configured for calculating, for each of the lamps 3A and 3B, an intention factor based on an instantaneous ratio between the test power and the reference power. As used herein, the term “test power” refers to the power of signals communicated over the directional channel 24, while the term “reference power” refers to the power of signals communicated over the omni-directional channel 26. Such functionality may, for example, be implemented with a processor 28 shown in FIG. 2. Test power is a function of the Euclidean distance as well as the angular distance between the remote control device 2 and the lamps 3A or 3B. On the contrary, reference power is a function of only the Euclidean distance between the remote control device 2 and the lamp 3A (for those angles where the signal receiver 25 is omni-directional, i.e., in the opening angle of the remote control device 2 or the lamps 3A or 3B). As a result, the instantaneous ratio is a function of only the angle between the remote control device 2 and the lamp 3A (denoted herein as ul). Thus, within the opening angle of the remote control device 2, the intention factor calculated in this manner is independent of attenuation due to distance, lampshades, etc. Further, as shown in FIG. 5, intention factor Q is a symmetrical and monotonic function of angle u, with a maximum at u=0, which makes the intention factor a good measure to base the selection of the lamp 3A on.

The processor 28 is configured to calculate a first intention factor based on an instantaneous ratio between Ptest1 and Pref1, and a second intention factor based on an instantaneous ratio between Ptest2 and Pref2. Thus, the intention factor may simply be the instantaneous ratio itself Alternatively, it may be a function of that ratio. For instance, the processor 28 may further be configured to calculate the first and/or second intention factors by integrating the first and second instantaneous ratios, respectively, over a time period. In operation, the time period could be e.g. a period when the person P pushes a control button on the remote control device 2. As long as the person P pushes the control button, the transmitters 20A and 20B transmit the first and second signals, respectively. Further, as long as the person P pushes the control button, the directional signal receiver 22 and the omni-directional signal receiver 25 determine instantaneous Ptest and Pref, respectively, for each of the first and second signals, and the processor 28 integrates the first and second instantaneous ratios to determine the first and second intention factors.

The controller 14 further comprises selection functionality for selecting the first lamp 3A when the first intention factor satisfies a first selection condition and selecting the second lamp 3B when the second intention factor satisfies a second selection condition. Such functionality may, for example, be implemented with a selector 29 shown in FIG. 2.

In one embodiment, the first selection condition could be e.g. that the first intention factor is greater than the second intention factor, and the second selection condition could be that the second intention factor is greater than the first intention factor. Intention factors calculated in the manners described above are indicative of the angle between the remote control device 2 and each of the lamps 3A and 3B: the smaller the angle, the greater the intention factor. Thus, in an example illustrated in FIG. 4A, the selector 29 would select the lamp 3A because the angle ul between the remote control device 2 and the lamp 3A is smaller than the angle u2 between the remote control device 2 and the lamp 3B. In this example, the selector 29 would not select the lamp 3B because the second intention factor would not satisfy the second selection condition.

Note that the selection on the basis of comparing the first and second intention factors may involve a corresponding selection on the basis of the derivations thereof, such as the signal strength of the first and second signals received at the directional signal receiver 22. As an example, the selected lamp 3A, 3B may be the lamp from which the strongest signal is received at the directional signal receiver 22.

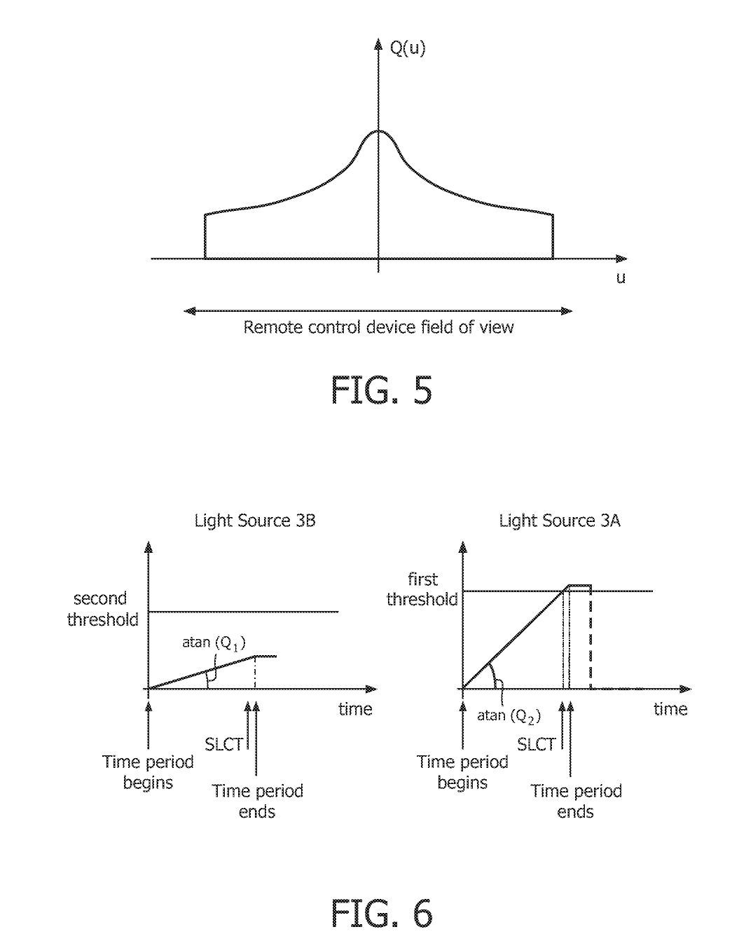

In another embodiment, the first selection condition could be that the first intention factor is greater than a first threshold value, and the second selection condition could be that the second intention factor is greater than a second threshold value. Continuing with the example illustrated in FIG. 4A, consider that the first and second threshold values are predetermined and the intention factors are determined by integrating the instantaneous ratios over a time period, where the time period is the period starting when the user starts pressing a control button on the remote control device 2 and ending when the user stops pressing the control button. Such a situation is illustrated in FIG. 6. The lamp 3A is at closer angular distance from the pointing direction of the remote control device 2 than the lamp 3B. Therefore, the intention factor for the lamp 3A increases faster than the intention factor for the lamp 3B. At the time shown in FIG. 6 as SLCT, the lamp 3A is selected because the first intention factor becomes greater than the first threshold value. Shortly after that the user stops pushing the control button and the processor 28 stops integrating the intention factors. At that time, the second intention factor is still below the second threshold value and thus lamp 3B is not selected.

Note, that if, however, the user continues pushing the control button, the lamp 3B may also eventually be selected, with a time delay with respect to the lamp 3A, illustrating that the threshold value influences the response time of the system. Hence, the threshold value should be set so that the waiting time is appropriate. However, it should be noticed that the threshold should not be too low, because small errors in the user pointing would quickly lead to wrong selections. Thus, the optimal threshold value should represent an acceptable trade-off between the waiting time and the selection accuracy. In one embodiment, the threshold values of the various target devices may be the same. However, in order to set priorities in the selection of target devices, different threshold values may be used for the different devices. For example, by setting the threshold value of a device to a value lower than all the other ones will lead to a facilitated selection of this device. This can be useful, for example, if the user has a preferred lamp that the user usually selects for control, like the “reading lamp.”

Furthermore, in an alternative embodiment, once one of the target devices is selected, selection of all of the subsequent target devices may be disabled. Such functionality may be implemented e.g. by including a stipulation in a selection condition that no other target devices are selected.

FIG. 4B is a schematic diagram of a directed transmitter system 1. The system comprises a first lamp 3A having a signal receiver 25A and a second lamp 3B having a signal receiver 25B. The remote control device 2 comprises the omni-directional signal transmitter 20 and the directional signal transmitter 27.

In operation, the omni-directional signal transmitter 20A transmits an omni-directional signal over the channel 26 and the directional signal transmitter 27 transmits a directional signal over the channel 24. Since it is desirable to be able to control the lamps 3A and 3B from any angle, the signal receivers 25A and 25B have a substantially omni-directional sensitivity pattern, at least within (a fraction of) an opening angle of the lamp 3. These sensitivity patterns are shown as patterns 32A and 32B for the lamps 3A and 3B, respectively.

Any technique that allows reliable detection and avoids interference between the directional and the omni-directional signals transmitted to the lamps 3A, 3B may be used. For example, frequency division multiple access (FDMA) technique may be used where the signal transmitters 20 and 27 use two different modulation frequencies, but any other technique for multiple access would function as well, such as time division multiple access or code division multiple access techniques. The directional signal may contain an identification code of the directional signal transmitter 27 and the omni-directional signal may contain an identification code of the omni-directional signal transmitter 20, where the identification codes are preferably chosen such that they are (quasi-) orthogonal with respect to each other in order to minimize interference between the first and second signals.

While the signal transmitters 20 and 27 are shown in FIGS. 3 and 4B to be overlapping, in practical situations, the signal transmitters 20 and 27 may be mounted in adjacent positions. This would lead to an approximation that is adequate when the distance between the remote control device 2 and the lamps 3A, 3B is significantly larger than the distance between the transmitters 20 and 27.

At each of the lamps 3A, 3B, the signal receiver 25 determines the power of the directional signal received from the directional signal transmitter 27 over the directional channel 24, Ptest 1 at the lamp 3A and Ptest2 at the lamp 3B. The signal receiver 25 also determines the power of the omni-directional signal received from the omni-directional signal transmitter 20 over the omni-directional channel 26, Pref1 at the lamp 3A and Pref2 at the lamp 3B.

Similar to the directed receiver system 5, the directed transmitter system 6 also includes processing means configured for determining, for each of the lamps 3A and 3B, an intention factor based on (a function of) an instantaneous ratio between the test power and the reference power and, optionally, integrating the instantaneous ratio over a time period in a manner described above. Furthermore, the directed transmitter system 6 also includes selecting means configured for selecting one or more of the lamps 3A, 3B in a manner described above. In one embodiment, the processing means may be implemented by including the processor 28 described above within each of the lamps 3A, 3B and the selecting means may be implemented by also including within each of the lamps 3A, 3B the selector 29 described above. In such an embodiment, each of the lamps 3A, 3B may select itself, independently of the other lamps, when the intention factor exceeds a certain threshold value.

Alternatively, the processing means and/or the selecting means may be implemented as the processor 28 and/or the selector 29 within the remote control device 2. In such embodiments, each of the lamps 3A and 3B may further include a transmitter (not shown in FIG. 4B) configured to transmit data indicative of the angle u1, u2 between the remote control device 2 and the lamp 3A or 3B (e.g., any combination of Ptest, Pref, and intention factor) to the remote control device 2. It should be noted that this data may also be received by an external device, such as another lamp 3C (see FIG. 4B), that makes the selection decision and reports the result to the remote control device 2 via module 17 (see fig.3). Lamp 3C may or may not itself have been subject to the selection process.

Similar to the directed receiver system 5, in the directed transmitter system 6 once one of the lamps 3A or 3B is selected, selection of the other lamp may be disabled.

The signal transmitter 20, 20A, 20B, 27, 27A, 27B in the above systems 1, 5, 6 may use optical signals, such as infrared signals. However, radio frequency signals (e.g. in the 60 GHz band) or ultrasound signals with a frequency of 20 kHz or higher may also be employed (of course, using suitable transmitters and receivers). Radio frequency signals have the advantage of penetrating certain materials (such as the shade of a lamp) thereby possibly improving the detection of the signals. Ultrasound may enable the use of measures other than signal strength (such as phase) as an indication of the angle between the remote control device 2 and each of the lamps 3A, 3B. It should be appreciated that the same signals may be used for selection of the lamps 3A, 3B as for sending commands to said selected device(s), e.g. infrared signal channels or radio frequency signal channels. Thus, modules 17 and 18 shown in FIGS. 2 and 3 may comprise modules for communicating infrared or ultrasound signals.

In case infrared signals are used, these signals may also be used for exchanging security keys between the remote control device 2 and the lamps 3A, 3B. These signals hardly leave the room where the system operates and are therefore difficult to intercept.

An extension of the directed receiver system 5 illustrated in FIGS. 2 and 4A includes N receivers in the remote control device 2, where N is greater than 2. Similarly, an extension of the directed transmitter system 6 illustrated in FIGS. 3 and 4B includes N transmitters in the remote control device 2. The N receivers (or transmitters) have increasing opening angles. For the N receivers (or transmitters), (N-1) independent intention factors may be defined as instantaneous ratios Power(n)/Power(n+1), where n=1, 2, . . . , N−1. These instantaneous ratios may, optionally, be integrated over a time period, and the decision to select one or more target devices may be based on the (N−1) intention factors, similar to the method described above. One advantage of determining more intention factors to base the selection of the target devices on is that better handling of pointing inaccuracy and reflections may be achieved, thereby reducing the risk of selecting wrong target devices.

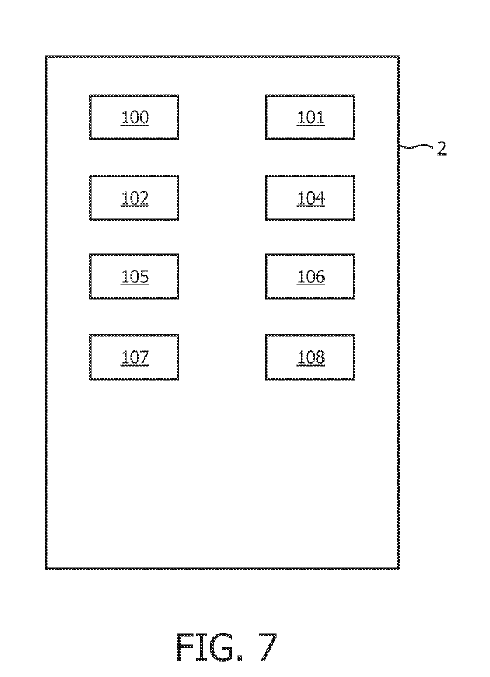

The remote control device 2 for the directed receiver system 5 and directed transmitter system 6 may have various other functionality that can be advantageously applied in such systems. FIG. 7 provides an overview for such a remote control device 2.

A delay module 100 may be implemented in the remote control device 2. The above-described methods of selection can be improved by delaying selection of a lamp 3A, 3B by a predetermined time interval to avoid spurious selection of a lamp if the remote control device 2 is swept across a lamp on its way to a targeted lamp. In other words, a lamp is only selected if it has the largest intention factor (i.e., the smallest angle between the remote control 2 and the lamp) for a minimum amount of time. An appropriate time interval may be, for example, in the range of 300-1500 ms.

A motion sensor 101 and a start module 102 may be implemented in the remote control device 2 for saving energy. When person P picks up the remote control device 2, in the directed receiver system 5, the remote control device 2 may broadcast a command to all lamps 3 to turn on the signal transmitters 20. In the directed transmitter system 6, the remote control device 2 starts its omni-directional signal transmitter 20 (as well as, possibly, the directional signal transmitter 27) and broadcasts to the lamps 3 a command to activate the signal receivers. Once a lamp 3A has been detected, the signal transmitter(s) and receiver(s) may be commanded to be switched off again.

As illustrated in FIGS. 2 and 3, the remote control device 2 comprises control buttons 15. Often, if a person P points at a lamp 3A, 3B, the remote control device 2 will move a little due to resistance/tactile feedback of the button, which may cause undesired selection of a lamp 3A, 3B. Module 103 makes sure that a command is sent to that lamp 3A, 3B which was the selected one a predetermined time interval (e.g. 100-300 ms) prior to depression of a button.

It may be advantageous to include only a subset of all lamps in the selection process in order to reduce network traffic or to improve signal-to-noise ratio. In the directed receiver system 5, the remote control device 2 may be configured for requesting some lamps to switch off the signal transmitter 20 on the basis of a first analysis of the signal strengths of the transmitters 20. Similarly, in the directed transmitter system 6, the remote control device 2 may have an estimator 105 configured for estimating a distance to the lamps 3A, 3B using the radio link RF signal strength and to request only those lamps 3A, 3B to report the data indicative of the angle that are within a predetermined distance from the remote control device 2.

Also, for the directed receiver system 5, the remote control device 2 may comprise means 106 for requesting identification codes from the first and second lamps 3A, 3B, respectively, only when these lamps are within a predetermined distance from the remote control device 2. This enables a reduced length of the identification codes and decreased cross interference. This can be obtained by a low power “wake-up message” from the remote control device 2 to the lamps 3A, 3B.

For the directed receiver system 5, it is advantageous to convert the network address to a shorter local address for use during the selection process, in order to improve the signal-to-noise ratio. The shorter local addresses may be assigned in an initialization step during installation of the system or be preset in a factory. To that end, the remote control device may have an address assigner 107 configured for receiving network addresses of the first and second lamp 3A, 3B and assigning local addresses, shorter than the network addresses, to these lamps for use in the first and second signal. A converter 108 configured for converting the local addresses to the network addresses for sending commands to said first and second target device may also be implemented in the remote control device. In operation, the remote control device 2 queries the lamps 3A, 3B over the radio link RF for the network addresses. The assignor 107 then assigns shorter addresses to be used by the first and second signal transmitters 20A, 20B. The converter, using e.g. a look-up table, of remote control device 2 converts between RF addresses and the short addresses.

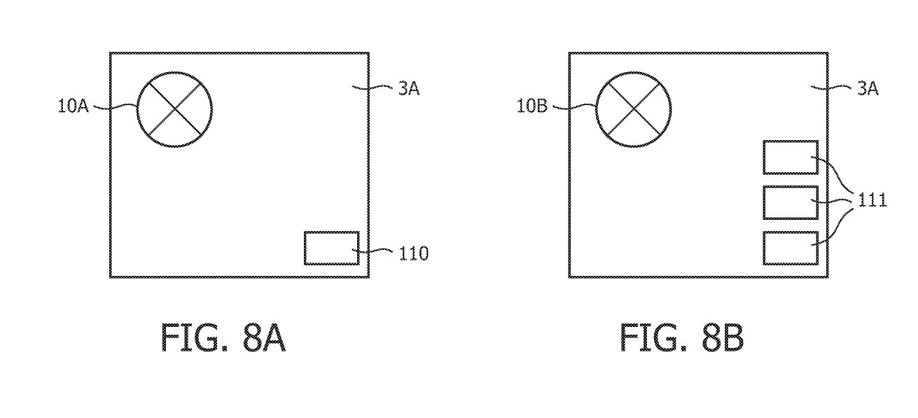

FIGS. 8A and 8B are schematic illustrations of a first lamp 3A according to embodiments of the invention. The first lamp 3A, comprising light emitting element 10A, may either be used in the directed receiver system or in the directed transmitter system.

It may be advantageous for person P to be informed which lamp has been selected using the above-described method. To that end, the lamp may comprise a visual indicator 110 (FIG. 8A) or a plurality of visual indicators 111 (FIG. 8B). Multiple visual indicators may be used, e.g. using different colors, to what extent the remote control device 2 is pointed at a particular lamp 3A, 3B. This functionality may also be obtained with a single visual indicator, e.g. by varying a flickering frequency of the light of the visual indicator. The visual indicators may be LED's. The visual indicators are turned on in response to a command over radio link RF from the remote control 2 that has finalized the selection process described above.

The selection methods described above may be used to select a lamp 3A or another device. Multiple devices may be selected subsequently to obtain a set of selected devices to which commands can be transmitted.

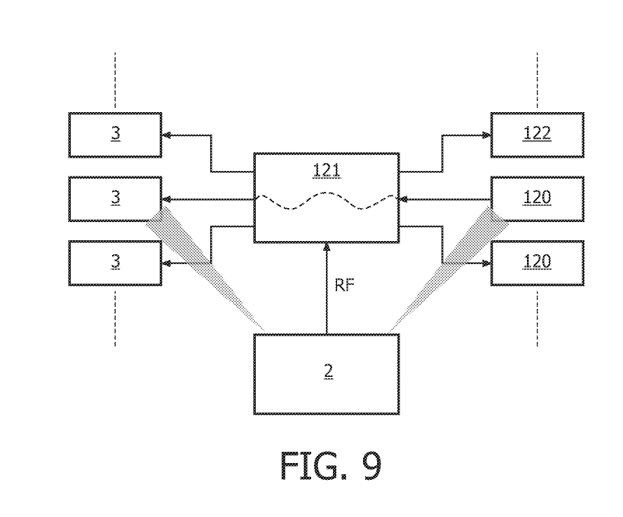

The selection methods may also be used for pairing applications, as schematically illustrated in FIG. 9.

Often a person P needs to pair multiple devices. For example, in many offices wall-switches 120 are not directly connected to lamps 3A-3C, but both lamp and switch are peripherals of a control box 121. The control box 121 must be programmed such that when a particular wall switch 120 is operated the lamp 3 in that room goes on/off. The programming of the control box and the wiring to it is very error-prone. Logically assigning wall-switches 120 (and motion detectors 122 etc.) to lamps 3 is often referred to as commissioning. The above selection methods can facilitate this process. The person P could put the system into commissioning mode using the remote control device 2 and then select a number of devices 3, 120 by pointing at them; the system would then perform the actual pairing over the omnidirectional channel RF. Even if the cabling is erroneous this will still assign the right switch 120 to the right lamp 3.

One advantage of the present invention is that a fast response time as well as good selection accuracy may be obtained. Other advantages include simple implementation and good ease of use for the point and control applications.

Persons skilled in the art will understand that the architecture described in FIGS. 2, 3, 4A and 4B in no way limits the scope of the present invention and that the techniques taught herein may be implemented in any properly configured wireless remote controlled device selection system without departing from the scope of the present invention.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the forgoing is directed to embodiments of the present invention, other and further embodiments of the invention may be devised without departing from the basic scope thereof For example, aspects of the present invention may be implemented in hardware or software or in a combination of hardware and software. Therefore, the scope of the present invention is determined by the claims that follow.

1. A wireless remote controlled device selection system comprising:
a first target device comprising a first signal transmitter configured for transmitting a first signal;
a second target device comprising a second signal transmitter configured for transmitting a second signal; and
a remote control device configured for selecting at least one of the first target device and the second target device and comprising:
a directional signal receiver configured for determining:
a first test power of the first signal transmitted from the first signal transmitter to the directional signal receiver; and
a second test power of the second signal transmitted from the second signal transmitter to the directional signal receiver, an omni-directional signal receiver configured for determining:
a first reference power of the first signal transmitted from the first signal transmitter to the omni-directional signal receiver; and
a second reference power of the second signal transmitted from the second signal transmitter to the omni-directional signal receiver, a processor configured for:
determining a first intention factor based on a first instantaneous ratio between the first test power and the first reference power, and
determining a second intention factor based on a second instantaneous ratio between the second test power and the second reference power, and a selector configured for:
selecting the first target device when the first intention factor satisfies a first selection condition, and
selecting the second target device when the second intention factor satisfies a second selection condition.

2. The system of claim 1, wherein the processor is further configured for at least one or:
determining the first intention factor by integrating the first instantaneous ratio over a time period; and
determining the second intention factor by integrating the second instantaneous ratio over the time period.

3. The system according to claim 1, wherein the first selection condition comprises the first intention factor being greater than the second intention factor, and the second selection condition comprises the second intention factor being greater than the first intention factor.

4. The system according to claim 1, wherein the first selection condition comprises the first intention factor being greater than a first threshold value, and the second selection condition comprises the second intention factor being greater than a second threshold value.

5. The system according to claim 1, wherein the first selection condition further comprises the second target device not being selected and/or the second selection condition further comprises the first target device not being selected.

6. A wireless remote controlled device selection system comprising:
a first target device comprising a first signal receiver;
a second target device comprising a second signal receiver;
a remote control device comprising:
a directional signal transmitter configured for transmitting a directional signal to the first signal receiver and to the second signal receiver, and
an omni-directional signal transmitter configured for transmitting an omni-directional signal to the first signal receiver and to the second signal receiver, wherein:
the first signal receiver is configured for determining:
a first test power of the directional signal transmitted from the directional signal transmitter to the first signal receiver, and
a first reference power of the omni-directional signal transmitted from the omni-directional signal transmitter to the first signal receiver; and
the second signal receiver is configured for determining:
a second test power of the directional signal transmitted from the directional signal transmitter to the second signal receiver, and
a second reference power of the omni-directional signal transmitted from the omni-directional signal transmitter to the second signal receiver, processing means for:
determining a first intention factor based on a first instantaneous ratio between the first test power and the first reference power, and
determining a second intention factor based on a second instantaneous ratio between the second test power and the second reference power; and
selecting means for selecting the first target device when the first intention factor satisfies a first selection condition, and selecting the second target device when the second intention factor satisfies a second selection condition.

7. The system according to claim 6, wherein the first selection condition comprises the first intention factor being greater than a first threshold value, and the second selection condition comprises the second intention factor being greater than a second threshold value.

8. The system according to claim 6, wherein:
the processing means comprises a first processor within the first target device and a second processor within the second target device, wherein the first processor is configured for determining the first intention factor and the second processor is configured for determining the second intention factor; and
the selecting means comprises a first selector within the first target device and a second selector within the second target device, wherein the first selector is configured for selecting the first target device when the first intention factor satisfies the first selection condition, and the second selector is configured for selecting the second target device when the second intention factor satisfies the second selection condition.

9. The system according to claim 8, wherein the first processor is further configured for determining the first intention factor by integrating the first instantaneous ratio over a time period, and/or the second processor is further configured for determining the second intention factor by integrating the second instantaneous ratio over the time period.

10. The system according to claim 6, wherein the first selection condition comprises the first intention factor being greater than the second intention factor, and the second selection condition comprises the second intention factor being greater than the first intention factor.

11. The system according to claim 6, wherein:
the first target device further comprises a first signal transmitter configured for transmitting the first test power, the first reference power, or a combination of the first test power and the first reference power, to the remote control device;
the second target device further comprises a second signal transmitter configured for transmitting the second test power, the second reference power, or a combination of the second test power and the second reference power to the remote control device;
the processing means comprises a processor within the remote control device; and
the selecting means comprises a selector within the remote control device.

12. The system according to claim 6, wherein the first selection condition further comprises the second target device not being selected, and the second selection condition further comprises the first target device not being selected.

13. A method for selecting at least one of a first target device comprising a first signal transmitter and a second target device comprising a second signal transmitter, comprising:
determining a first test power of a first signal transmitted from the first signal transmitter to a directional signal receiver;
determining a second test power of a second signal transmitted from the second signal transmitter to the directional signal receiver;
determining a first reference power of the first signal transmitted from the first signal transmitter to an omni-directional signal receiver;
determining a second reference power of the second signal transmitted from the second signal transmitter to the omni-directional signal receiver;
determining a first intention factor based on an instantaneous ratio between the first test power and the first reference power;
determining a second intention factor based on an instantaneous ratio between the second test power and the second reference power;
selecting the first target device when the first intention factor satisfies a first selection condition, and selecting the second target device when the second intention factor satisfies a second selection condition.

14. A method for selecting at least one of a first target device comprising a first signal receiver and a second target device comprising a second signal receiver, comprising:
determining a first test power of a directional signal transmitted from a directional signal transmitter to the first signal receiver;
determining a first reference power of an omni-directional signal transmitted from an omni-directional signal transmitter to the first signal receiver;
determining a second test power of the directional signal transmitted from the directional signal transmitter to the second signal receiver;
determining a second reference power of the omni-directional signal transmitted from the omni-directional signal transmitter to the second signal receiver;
determining a first intention factor based on an instantaneous ratio between the first test power and the first reference power;
determining a second intention factor based on an instantaneous ratio between the second test power and the second reference power;
selecting means for selecting the first target device when the first intention factor satisfies a first selection condition, and selecting the second target device when the second intention factor satisfies a second selection condition.

15. The method of claim 14, further comprising at least one of the steps of:
determining the first intention factor by integrating the first instantaneous ratio over a time period; and
determining the second intention factor by integrating the second instantaneous ratio over the time period.

16. The method of claim 13, further comprising at least one of the steps of:
determining the first intention factor by integrating the first instantaneous ratio over a time period; and
determining the second intention factor by integrating the second instantaneous ratio over the time period.
